(19) United States
(12) Patent Application Publication
(10) Pub. No.: US 2026/0181282 A1
(43) Pub. Date: Jun. 25, 2026

(54) METHOD OF DETECTING A DEFOCUS OF AN IMAGE SENSOR AND IMAGE SENSOR

(71) Applicant: OMNIVISION TECHNOLOGIES, INC., Santa Clara, CA (US)

(72) Inventors: Yiyi Ren, Cupertino, CA (US); Lei Fan, Santa Clara, CA (US); Xiaodong Yang, San Jose, CA (US); Chengming Liu, Fremont, CA (US)

(73) Assignee: OMNIVISION TECHNOLOGIES, INC., Santa Clara, CA (US)

(21) Appl. No.: 19/001,419

(22) Filed: Dec. 25, 2024

(51) Int. Cl. H04N 25/674; H04N 25/707

(52) U.S. Cl. CPC H04N 25/674; H04N 25/707

(57) ABSTRACT

A method of detecting a defocus of an image sensor and an image sensor applicable to perform the method are provided herein. The image sensor including a first subpixel and a second subpixel. The first subpixel includes m photodiode units and a first microlens structure overlaying the photodiode units, and m is an integer. The second subpixel includes m photodiode units and a second microlens structure overlaying the photodiode units. The first microlens structure is structurally different from the second microlens structure. First readout values of the photodiode units of the first subpixel are interpolated to positions of n of the photodiode units of the second subpixel to obtain interpolated values, wherein n is an integer. An imbalance value is obtained by using the interpolated values and second readout values provided by the n of the photodiode units of the second subpixel.

### BACKGROUND

### Technical Field

The disclosure is related to a method of detecting a defocus of an image sensor and an image sensor.

### Description of Related Art

Image sensors are widely used in digital still cameras, cellular phones, security cameras, as well as medical, automotive, and other applications. In some applications, each pixel of the image sensor includes several subpixels (e.g., two green subpixels, one red subpixel, and one blue subpixel). Individual subpixels are implemented by photodiodes covered with microlenses. One of the designs of the image sensor adopts a large microlens cover multiple photodiodes to enable autofocus function. However, such design fails to determine whether the image is defocused or in-focus in certain situation such as images on high frequency regions and defocus edges.

### BRIEF DESCRIPTION OF THE DRAWINGS

FIG. 1 is a schematic diagram of an image sensor in accordance with an embodiment of the disclosure.

FIG. 2 is a schematic diagram showing a method of a defocus detection of an image sensor in accordance with some embodiments of the disclosure.

FIG. 3 schematically illustrate a step of interpolating the first readout values to obtain interpolated values in accordance with some embodiments.

FIG. 4 is a schematic diagram of an image sensor in accordance with an embodiment of the disclosure.

FIG. 5 is a schematic diagram of an image sensor in accordance with an embodiment of the disclosure.

FIG. 6 is a schematic diagram of an image sensor in accordance with an embodiment of the disclosure.

FIG. 7 is a schematic diagram of a side view of two subpixels in accordance with some embodiments of the disclosure.

FIG. 8 is a schematic diagram of an image sensor in accordance with an embodiment of the disclosure.

FIG. 9 is a schematic diagram of an image sensor in accordance with an embodiment of the disclosure.

FIG. 10 a schematic diagram of a defocus detection pixel in an image sensor in accordance with an embodiment of the disclosure.

FIG. 11 is a schematic diagram of a defocus detection pixel in an image sensor in accordance with an embodiment of the disclosure.

FIG. 12 a schematic diagram of a defocus detection pixel in an image sensor in accordance with an embodiment of the disclosure.

FIG. 13 a schematic diagram of a defocus detection pixel in an image sensor in accordance with an embodiment of the disclosure.

FIG. 14 a schematic diagram of a defocus detection pixel in an image sensor in accordance with an embodiment of the disclosure.

FIG. 15 a schematic diagram of a defocus detection pixel in an image sensor in accordance with an embodiment of the disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention.

### DESCRIPTION OF THE EMBODIMENTS

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

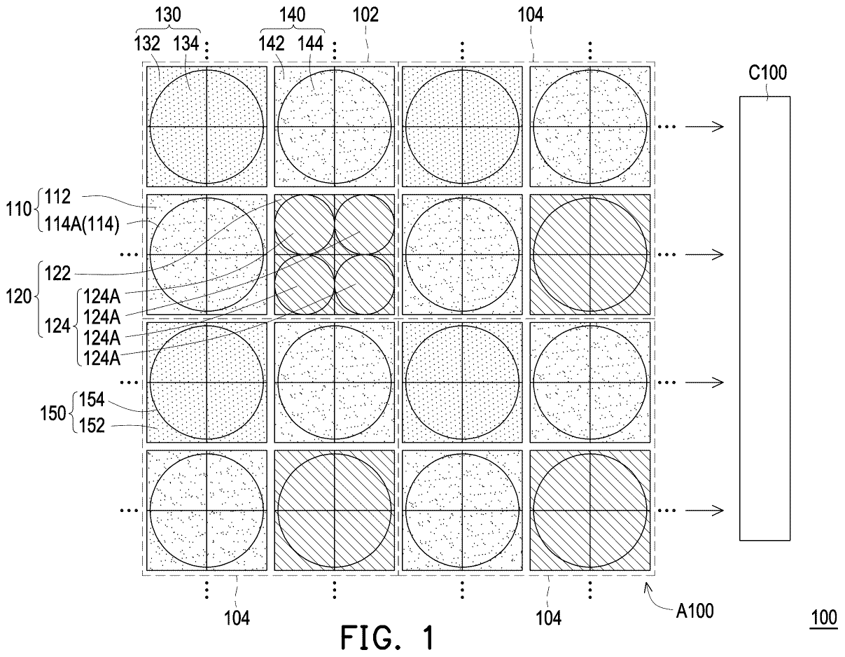

FIG. 1 is a schematic diagram of an image sensor in accordance with an embodiment of the disclosure. An image sensor 100 shown in FIG. 1 includes a pixel array A100 that includes a defocus detection pixel 102 and other pixels 104 around the defocus detection pixel 102. In the embodiments, the defocus detection pixel 102 and each pixel 104 are implemented by different designs. For example, the defocus detection pixel 102 may have a complex microlens structure and the pixel 104 may have a uniformed microlens structure, which will be describe in the following description. In some embodiments, the image sensor 100 may be formed by a plurality of the pixel array A100 and the pixel array A100 may include a first quantity of the defocus detection pixel 102 and a second quantity of the pixel 104, wherein the first quantity is different from the second quantity. For example, the first quantity is less than the second quantity, but the disclosure is not limited thereto. FIG. 1 shows that the image sensor 100 includes a pixel array A100 of 2×2 pixels, where one pixel is the defocus detection pixel 102 and the other three pixels 104 disposed around the defocus pixel 102 may have the same structural design. In some embodiments, the pixel array A100 may be formed by an array of P×P pixels while Q of the pixels in the pixel array A100 may be implemented by the defocus detection pixel 102 and others of the pixels may be implemented by the pixel 104. P is an integer greater than 2, for example, 3, 4 . . . or other numbers. Q may is a positive integer less than or equal to P. In addition, the image sensor 100 may further include a readout circuitry C100 that is electrically connected to the defocus detection pixel 102 and the three pixels 104. The readout circuitry C100 is configured to receive and process the readout values provided by the defocus detection pixel 102 and the pixels 104.

In the embodiment, the defocus detection pixel 102 has a complex microlens structure. Specifically, the defocus detection pixel 102 of the image sensor 100 includes a first subpixel 110 and a second subpixel 120. The first subpixel 110 includes m photodiode units 112 providing first readout values and a first microlens structure 114 overlaying the photodiode units 112. The second subpixel 120 includes m photodiode units 122 providing second readout values and a second microlens structure 124 overlaying the photodiode units 122, wherein m is a positive integer. In the embodiment, m is 4, but the disclosure is not limited thereto. The four photodiode units 112 of the first subpixel 112 are arranged in a 2×2 array and may be binned to sense the same color of an incident light, for example, green. Simultaneously, the four photodiode units 122 of the second subpixel 120 are arranged in a 2×2 array and may be binned to sense the same color of an incident light, for example, red. Accordingly, the first subpixel 110 and the second subpixel 120 located next to each other in the row direction are used for sensing different colors of an incident light.

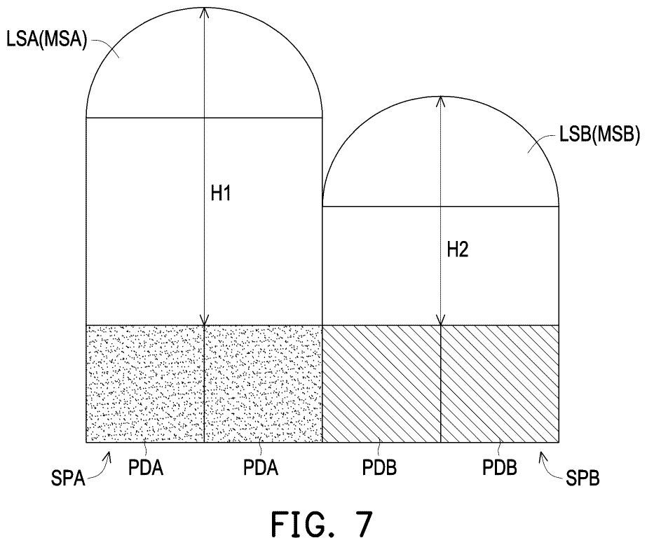

In the embodiment, the first microlens structure 114 is structurally different from the second microlens structure 124. As shown in FIG. 1, the first microlens structure 114 is implemented by one single microlens 114A. The microlens 114A of the first microlens structure 114 is disposed overlaying 4 photodiode units 112 of the first subpixel 112 arranged in a 2×2 array, which may be called as a quad photodiode (QPD) configuration. The second microlens structure 124 is implemented by 4 microlenses 124A and each of the microlenses 124 of the second microlens structure 124 is disposed overlaying a single one of the photodiode units 122 of the second subpixel 122, which forms a 4C configuration. The microlens 114A of the first microlens structure 114 has a diameter greater than each of the microlenses 124A of the second microlens structure 124 in the top view. Therefore, the second microlens structure 124 is structurally different from the first microlens structure 114 in the top view. In some alternative embodiments, the structural difference between the first microlens structure 114 and the second microlens structure 124 may be observed from the side view rather than the top view as will be described later in the disclosure (FIG. 7).

In the embodiment, the first subpixel 102 of the image sensor 100 further includes a third subpixel 130 and one further first subpixel 140. The first subpixel 110, the second subpixel 120, the third subpixel 130 and the other first subpixel 140 are arranged in a 2×2 array. The third subpixel 130 may be configured to sense a different color of the incident light from the first subpixel 110 and the second subpixel 120, and the other first subpixel 140 may be configured to sense the same color of the incident light as the first subpixel 110. For example, the first subpixel 110 and the other first subpixel 140 may be configured to sense green of the incident light and the second subpixel 120 may be configured to sense red of the incident light, and the third subpixel 130 may be configured to sense blue of the incident light. In the embodiment, the defocus detection pixel 102 includes four subpixels implemented by a Bayer pattern, in which two green subpixels, one red subpixel and one blue subpixel are arranged in a 2×2 array. For example, two green subpixels (the first subpixel 110 and the other first subpixel 140) are arranged at the lower left portion and the upper right portion, respectively, the red subpixel (the second subpixel 120) is arranged at the lower right portion, and the blue subpixel (the third subpixel 130) is arranged at the upper left portion. In addition, the red subpixel has a different microlens structure than other subpixels to implement the defocus detection pixel 102.

The third subpixel 130 in the embodiment includes 4 photodiode units 132 arranged in a 2×2 array and a third microlens structure 134 overlaying the photodiode units 132. The photodiode units 132 arranged in a 2×2 array may be binned to sense the same color of incident light, such as blue. The third microlens structure 134 of the third subpixel 130 may have a structure substantially the same as the first microlens structure 114 of the first subpixel 110. For example, the third microlens structure 134 include one single microlens overlaying four photodiode units 132 arranged in a 2×2 array. In other words, the third subpixel 130 is implemented by a QPD configuration.

The other first subpixel 140 includes photodiode units 142 arranged in a 2×2 array and another first microlens structure 144 overlaying the photodiode units 142. The photodiode units 142 arranged in a 2×2 array may be binned to sense the same color of incident light, such as green. The other first microlens structure 144 of the other first subpixel 140 may have a structure substantially the same as the first microlens structure 114 of the first subpixel 110. For example, the other first microlens structure 144 includes one single microlens overlaying four photodiode units 142 arranged in a 2×2 array. In other words, in the embodiment, the first subpixel 110, the third subpixel 130 and the other first subpixel 140 are respectively implemented by a QPD configuration while the second subpixel 120 is implemented by a 4C configuration, which renders the defocus detection pixel 102 has a complex microlens structure.

In the embodiment, each of the pixels 104 includes 4 image subpixels 150. Specifically, four image subpixels 150 in one pixel 104 are arranged in a 2×2 array, in which two image subpixels 150 located at the upper right portion and the lower left portion of the pixel 104 are green subpixels, one image subpixel 150 located at the lower right portion of the pixel 104 is a red subpixel and the other image subpixel 150 located at the upper left portion of the pixel 104 is a blue subpixel so as to form a Bayer pattern configuration. In addition, each of the image subpixels 105 includes m photodiode units 152 providing image readout values and a repeating microlens structure 154 overlaying the photodiode units 152. The repeating microlens structure 154 may have a same structure as the first microlens structure 114. For example, the repeating microlens structure 154 includes one single microlens overlaying four photodiode units 152. In other words, in the embodiment, all image subpixels 150 in each of the pixel 104 are implemented by a QPD configuration and thus the pixel has a uniformed microlens structure.

In the embodiment, the first readout values provided by the first subpixel 110, the second readout values provided by the second subpixel 120, the third readout values provided by the third subpixel 130, the fourth readout values provided by the other first subpixel 140, and the image readout values provided by the image subpixels 150 are received and processed by the readout circuitry C100 to generate a sensed image. In addition, the defocus detection pixel 102 having a complex microlens structure may further enables a defocus detection of the image sensor 100.

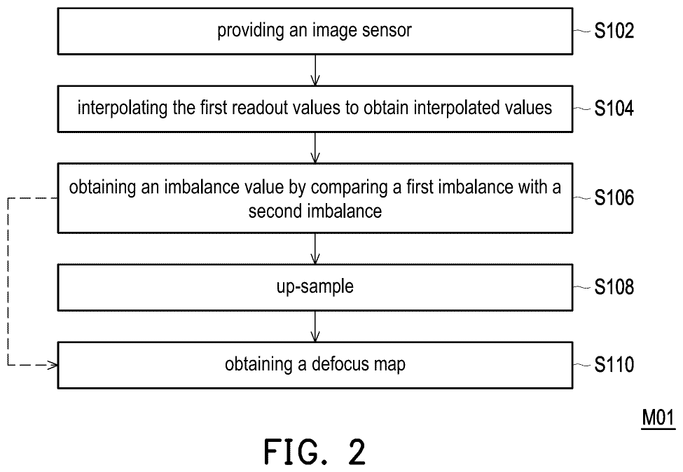

FIG. 2 is a schematic diagram showing a method of a defocus detection of an image sensor in accordance with some embodiments of the disclosure. The method M01 shown in FIG. 2 may be processed in the readout circuitry C100 of the image sensor 100 shown in FIG. 1. In the embodiment, the method M01 includes a step S102 of providing an image sensor, wherein the image sensor includes at least one subpixel implemented by a microlens structure different from other subpixels. For example, the image sensor 100 as shown in FIG. 1 is provided to perform the method M01, wherein the second subpixel 120 in defocus detection pixel 102 has a microlens structure different from other subpixels such as the first subpixel 110, the third subpixel 130, and the other first subpixel 140. In the embodiment, the photodiode units 112 in the first subpixel 110 are configured to provide first readout values and the photodiode units 122 in the second subpixel 110 are configured to provide second readout values. The first readout values and the second readout values direct to the sensed results in response to different colors of an incident light. For example, the first readout values direct to the sensed results in response to green of an incident light and the second readout values direct to the sensed results in response to red of an incident light, but the disclosure is not limited thereto.

In the embodiments, the first microlens structure 114 included in the first subpixel 110 is structurally different from the second microlens structure 124 included in the second subpixel 120. For example, the first microlens structure 114 is implemented by a QPD configuration which allows fast autofocus and the second microlens structure 124 is implemented by a 4C configuration which is difficult to perform autofocus. Accordingly, the different microlens structure of the second subpixel 120 results in a different focus condition from the first subpixel 110 and the defocus of the image sensor 100 may be determined by comparing the sensed results of the first subpixel 110 and the second subpixel 120. In the embodiment, for comparing the sensed results of the first subpixel 110 and the second subpixel 120, the method M01 further includes a step S104 of interpolating the first readout values of the photodiode units 112 of the first subpixel 110 and the first readout values of the photodiode units 142 of the other first subpixel 140 to positions of n of the photodiode units 122 of the second subpixel 120 to obtain interpolated values A₁˜Aₙ, wherein n is a positive integer. In some embodiments, n may be determined by the different microlens structure design of the second microlens structure 124 of the second subpixel 120. For example, the different microlens structure design of the second microlens structure 124 is implemented by four microlenses 124A over 4 photodiode units 122 and thus n is 4.

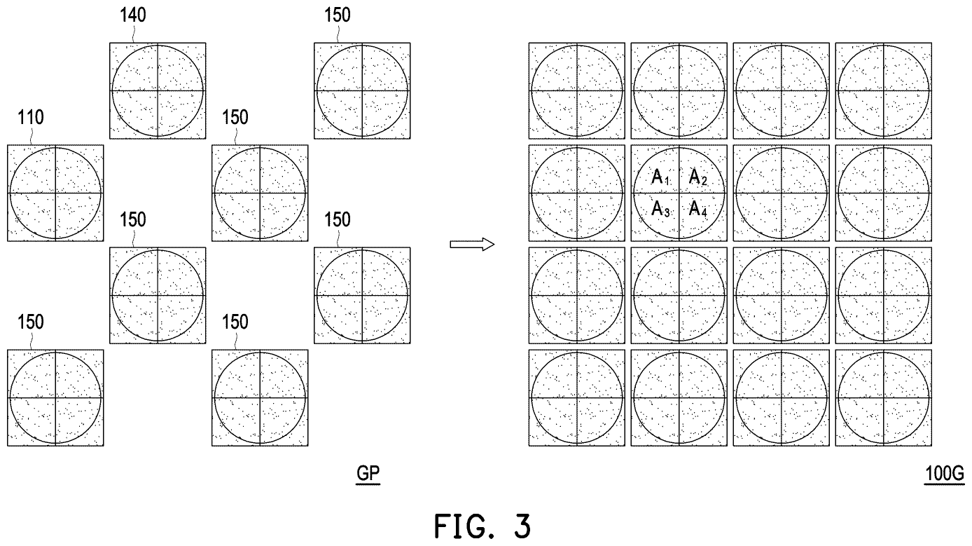

FIG. 3 schematically illustrate a step of interpolating the first readout values to obtain interpolated values in accordance with some embodiments. As shown in FIG. 3, in the embodiment, the image sensor 100 includes a number of green subpixels GP configured to sense green of the incident light, such as the first subpixels 110 and 140 in the defocus detection pixel 102 and some of the image subpixels 150 in the second subpixels 104. The readout values provided by the photodiode units of these green subpixels GP are processed to obtain a green map 100G by performing at least an interpolation step. In the green map 100G, the interpolated values A₁˜Aₙ at the positions of the n of the photodiode units 122 in the second subpixel 120 are obtained and utilized for the method M01, wherein n is 4 in the embodiment since the different microlens structure design of the second microlens structure 124 is implemented by four microlenses 124A over 4 photodiode units 122. Various interpolating algorithms are available. Anyone of them may be applied to the method M01 of FIG. 2.

Referring to FIG. 2 and FIG. 3, the method M01 further includes a step S106 of obtaining an imbalance value by comparing a first imbalance of the interpolated values A₁˜Aₙ with a second imbalance of the second readout values B₁˜Bₙ provided by the n of the photodiode units 122 of the second subpixel 120. The interpolated values A₁˜Aₙ represents interpolated values obtained from the steps shown in FIG. 3 while the second readout values B˜Bₙ represent the values directly readout from the photodiode units 122 at the positions of the photodiode units 122 covered by the microlenses 124A of the second microlens structure 124.

In some embodiments, the first imbalance imbal_{A} of the interpolated values A₁˜Aₙ is obtained by equation 1:

$${imbal}_{A} = \frac{max ( {A}_{1} , {A}_{2} , … {A}_{n} )}{min ( {A}_{1} , {A}_{2} , … {A}_{n} )} , \qquad ( 1 )$$

wherein A₁ . . . Aₙ are the interpolated values A₁ . . . Aₙ; and the second imbalance imbal_{B} of the second readout values B₁˜Bₙ is obtained by equation 2:

$${imbal}_{B} = \frac{max ( {B}_{1} , {B}_{2} , … {B}_{n} )}{min ( {B}_{1} , {B}_{2} , … {B}_{n} )} , \qquad ( 2 )$$

wherein B₁ . . . Bₙ are the second readout value B₁ . . . Bₙ provided by the n of the photodiode units 122 of the second subpixel 120.

In some alternative embodiments, the first imbalance imbal_{A} of the interpolated values A₁˜Aₙ is obtained by equation 3:

$${imbal}_{A} = \frac{max ( {A}_{1} , {A}_{2} , … {A}_{n} )}{‖ ( {A}_{1} , {A}_{2} , … , {A}_{n} ) ‖} , \qquad ( 3 )$$

wherein A₁ . . . Aₙ are the interpolated values A₁ . . . Aₙ, and ∥·∥ is a norm; and the second imbalance imbal_{B} of the second readout values B₁˜Bₙ is obtained by equation 4:

$${imbal}_{B} = \frac{max ( {B}_{1} , {B}_{2} , … {B}_{n} )}{‖ ( {B}_{1} , {B}_{2} , … , {B}_{n} ) ‖} , \qquad ( 4 )$$

wherein B₁ . . . Bₙ are the second readout value B₁ . . . Bₙ provided by the n of the photodiode units 122 of the second subpixel 120, and ∥·∥ is a norm.

In some embodiments, the imbalance value imbal_diff may be obtained by equation 5:

$$imbal\_diff = \frac{{imbal}_{A}}{{imbal}_{B}} - 1 , \qquad ( 5 )$$

wherein imbal_{A} is the first imbalance obtained from the equation 1, and imbal_{B} is the second imbalance obtained from the equation 2; or imbal_{A} is the first imbalance obtained from the equation 3, and imbal_{B} is the second imbalance obtained from the equation 4.

In some embodiments, the imbalance value imbal_diff may be obtained by equation 6:

$$imbal\_diff = ‖ {imbal}_{A} - {imbal}_{B} ‖ , \qquad ( 6 )$$

wherein imbal_{A} is the first imbalance obtained from the equation 1, and imbal_{B} is the second imbalance obtained from the equation 2, or imbal_{A} is the first imbalance obtained from the equation 3, and imbal_{B} is the second imbalance obtained from the equation 4. In addition, ∥·∥ is a norm.

In other words, the imbalance value imbal_diff depends on

$$\frac{{imbal}_{A}}{{imbal}_{B}}$$

or (imbal_{A}−imbal_{B}).

In some embodiments, when n is 4, the first imbalance patch is obtained by equation 7:

$${patch}_{A} = [ \begin{matrix}{A}_{1} & {A}_{2} \\ {A}_{3} & {A}_{4}\end{matrix} ] , \qquad ( 7 )$$

wherein A₁ . . . A₄ are the interpolated values A₁ . . . A₄; and the second imbalance patch is obtained by equation 8:

$${patch}_{B} = [ \begin{matrix}{B}_{1} & {B}_{2} \\ {B}_{3} & {B}_{4}\end{matrix} ] , \qquad ( 8 )$$

wherein B₁ . . . B₄ are the second readout value B₁ . . . Bₙ provided by the n of the photodiode units 122 of the second subpixel 120.

In some embodiments, the imbalance value imbal_{diff} may be obtained by equation 9:

$${imbal}_{diff} = ‖ ( {∇}_{H} ( \frac{A}{‖ A ‖} ) - {∇}_{H} ( \frac{B}{‖ B ‖} ) , {∇}_{V} ( \frac{A}{‖ A ‖} ) - {∇}_{V} ( \frac{B}{‖ B ‖} ) ) ‖ , \qquad ( 9 )$$

wherein A is the first imbalance patch obtained from equation 7, and B is the second imbalance patch obtained from equation 8, and wherein ∇_{H} means gradients along a horizontal direction, and ∇_{V} means gradients along a vertical direction in the imbalance patch. The horizon direction and the vertical direction may refer to the row direction and the column direction of the array of the photodiode units in the image sensor 100.

In some embodiments, the imbalance value imbal_{diff} may be obtained by equation 10:

$${imbal}_{diff} = \frac{‖ ( {∇}_{H} ( \frac{A}{‖ A ‖} ) , {∇}_{V} ( \frac{A}{‖ A ‖} ) ‖}{‖ ( {∇}_{H} ( \frac{B}{‖ B ‖} ) , {∇}_{V} ( \frac{B}{‖ B ‖} ) ) ‖} - 1 , \qquad ( 10 )$$

wherein A is the first imbalance patch obtained from equation 7, and B is the second imbalance patch obtained from equation 8, and wherein ∇_{H} means gradients along a horizontal direction, and ∇_{V} means gradients along a vertical direction in the imbalance patch. The horizon direction and the vertical direction may refer to the row direction and the column direction of the array of the photodiode units in the image sensor 100.

It is understood that ∥·∥ is a norm, which is expressed in equation 11:

$$‖ ( {x}_{1} , {x}_{2} , … , {x}_{N} ) ‖ = {( {\sum }_{i = 1}^{N} ( {( {x}_{i} )}^{k} ) )}^{\frac{1}{k}} , \qquad ( 11 )$$

wherein N is the number of elements of x and k is and positive integer.

In some embodiments, the imbalance value imbal_{diff} is optionally obtained by equation 12:

$$i m b a {l}_{diff} = 1 - \frac{cov ( A , B )}{\sqrt[2]{var ( A ) var ( B )}} , \qquad ( 12 )$$

wherein A is the first imbalance patch obtained from equation 7, and B is the second imbalance patch obtained from equation 8. Cov is covariance, and for example, cov(A,B) is mean((A−mean(A))(B−mean(B)). Var is variance, and for example, var(A) is mean of square of ((A−mean(A)).

The method M01 of FIG. 2 comprises interpolating the first readout values of the photodiode units of the first subpixel to positions of n of the photodiode units of the second subpixel to obtain interpolated values, wherein n is a positive integer, and obtaining an imbalance value by using the interpolated values and the second readout values provided by the n of the photodiode units of the second subpixel.

The image sensor 100 may be implemented by repeating the pixel array A100 shown in FIG. 1 and include a plurality of the second subpixels 120 sparsely arranged therein. The steps S104 and S106 may be performed for each of the second subpixels 120 to obtain a plurality of imbalance values with respect to the positions of the second subpixels 120. The method M01 may further include a step S108 of up-sample, e.g., by increasing the number of second subpixels 120 in pixel array A100, and a step S110 of obtaining a defocus map based on the imbalance values. The imbalance values with respective to the second subpixels 120 are plotted to obtain a defocus map according to the positions of the different microlens structure of the second subpixels 120. Here, the imbalance value reflects the focus status at the specific portion and the larger the imbalance value is the greater the defocus is. In some embodiments, the step S108 of up-sample may be optionally performed to increase the resolution of the defocus map since the second subpixels 120 are sparsely arranged in the image sensor 100. In other words, in the case that the different microlens structure of the second subpixels 120 is arranged in a sufficient density, the step S108 is omitted and the step S110 is performed right after the imbalance values are obtained by the step S106 as shown by the dashed arrow in FIG. 2. The defocus map obtained by the method M01 may reflect the defocus level of the sensed results at various positions of the image sensor, which helps to determine whether a defocus occurs. Once the defocus map presents defocus at a specific region, the image sensor 100 may perform an adaptive low-pass-filter (LPF) by increasing more blurring filter. Once the defocus map presents in focus at a specific region, the image sensor 100 may not perform an adjustment to the image. Accordingly, the method M01 helps the image sensor 100 to distinguish whether a poor image is caused by defocus or other effects.

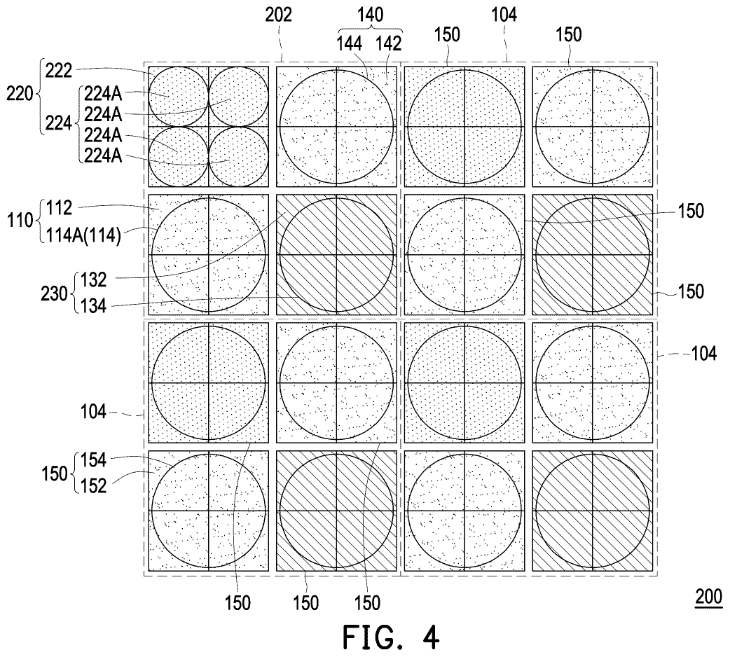

FIG. 4 is a schematic diagram of an image sensor in accordance with an embodiment of the disclosure. An image sensor 200 shown in FIG. 4 includes an array of pixels and the pixels include a defocus detection pixel 202 and other pixels 104 around the defocus detection pixel 202. The defocus detection pixel 202 may have a complex microlens structure and the pixels 104 may have a uniformed microlens structure. The defocus detection pixel 202 of the image sensor 200 includes a first subpixel 110, a second subpixel 220, a third subpixel 230 and another first subpixel 140 arranged in a 2×2 array. The defocus detection pixel 220 in the embodiment is different from the defocus detection pixel 102 of the image sensor 100 in that the subpixel having a different microlens structure from other subpixels is implemented in a blue subpixel in the embodiment. Other pixels 104 around the defocus detection pixel 102 may be implemented by the same design as the pixels 104 shown in FIG. 1 and thus the designs of the pixels 104 in the embodiment may refer to the descriptions for the pixels 104 in FIG. 1. Specifically, each of the pixel 104 of the image sensor 200 includes image subpixels 150 arranged in a 2×2 array and the imaged subpixels 150 are implemented by the same structure design, for example, QPD configuration. In addition, the designs of the first subpixel 110, the other first subpixel 140 and the image subpixels 150 may refer to the descriptions in the embodiment of FIG. 1. For example, each of the first subpixel 110, the other first subpixel 140 and the image subpixels 150 is implemented by a QPD configuration. In the embodiment, the third subpixel 230 is also implemented by a QPD configuration, but the second subpixel 220 is not.

In the defocus detection pixel 202 of the embodiment, the second subpixel 220 is located at the upper left portion, the first subpixel 110 is located at the lower left portion, the other first subpixel 140 is located at the upper right portion and the third subpixel 230 is located at the lower right portion. Therefore, the upper left subpixel has a structure different from the other subpixels in the defocus detection pixel 202. The first subpixel 110 and the other first subpixel 140 may be green subpixels while the second subpixel 220 is a blue subpixel and the third subpixel 230 is a red subpixel to construct a Bayer pattern arrangement. Comparably, the defocus detection pixel 102 in the embodiment of FIG. 1 is implemented that the lower right subpixel (red subpixel) has a different microlens structure from other subpixels. In the embodiment, the first subpixel 110, the third subpixel 230 and the other first subpixel 140 are implemented by a QPD configuration and the second subpixel 220 is implemented by a 4C configuration.

Specifically, the first subpixel 110 includes m photodiode units 112 providing first readout values and a first microlens structure 114 overlaying the photodiode units 112, wherein m is 4. The first microlens structure 114 is implemented by one single microlens 114A overlaying four photodiode units 112. The second subpixel 220 includes m photodiode units 222 providing second readout values and a second microlens structure 224 overlaying the photodiode units 122, wherein m is 4. In addition, the second microlens structure 224 is implemented by 4 microlenses 224A and each of the microlenses 224A is disposed overlaying a single one of the photodiode units 222 of the second subpixel 222, which may be called as a 4C configuration. The second subpixel 220 may have the same structural design as the second subpixel 120 of the image sensor 100 depicted in FIG. 1, but the second subpixel 220 and the second subpixel 120 may be located at different positions in a pixel and sense different colors of an incident light. Specifically, each of the pixels in the image sensor 200 and the image sensor 100 is implemented by a common pattern where two green subpixels diagonally arranged at the upper right portion and the lower left portion, respectively, and the blue subpixel and the red subpixel are arranged diagonally at the upper left portion and the lower right portion, respectively, but the subpixels have a different microlens structure in the image sensor 200 is the blue subpixel while the subpixel have a different microlens structure in the image sensor 100 is the red subpixel.

In the embodiment, the readout values of the photodiode units 222 in the second subpixel 220 may be utilized in a method M01 shown in FIG. 2 and FIG. 3. For example, a step S102 of providing an image sensor 200; a step S104 of interpolating the first readout values of the photodiode units 112 of the first subpixel 112 (and other green subpixels) to positions of n of the photodiode units 222 of the second subpixel 220 to obtain interpolated values A₁˜Aₙ; a step S106 of obtaining an imbalance value by comparing a first imbalance of the interpolated values A₁˜Aₙ with a second imbalance of the second readout values B₁˜Bₙ provided by the n of the photodiode units 222 of the second subpixel 220; a step S108 of up-sample; and a step S110 of obtaining a defocus map based on the imbalance values are sequentially performed. In addition, the first imbalance, the second imbalance and the imbalance value may be obtained by a combination of the equations 1˜9 described above and not be reiterated here. In the embodiment, n is determined by the number of the photodiode units 222 covered by the microlens 224A having a different structure from other microlenses. For example, n is 4 in the embodiment. The defocus map of the image sensor 200 may be utilized to determine whether an adjustment/correction of the resulted image is required.

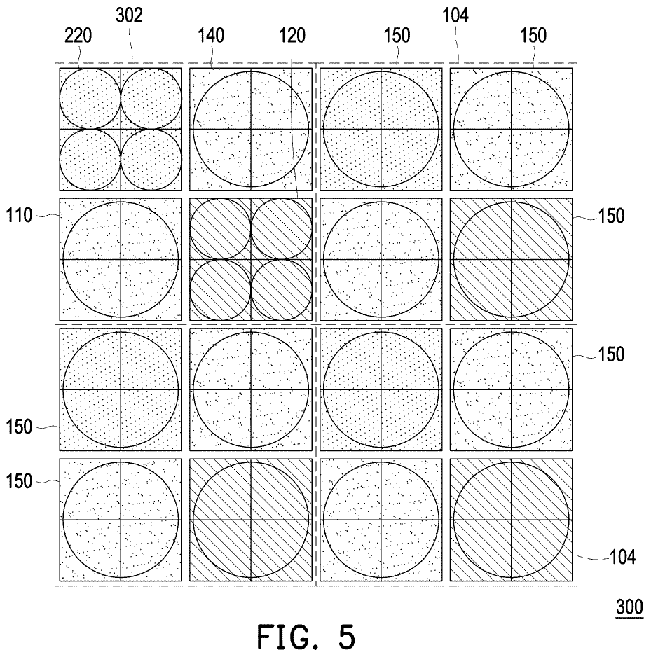

FIG. 5 is a schematic diagram of an image sensor in accordance with an embodiment of the disclosure. An image sensor 300 shown in FIG. 5 includes an array of pixels and the pixels include a defocus detection pixel 302 and other pixels 104 around the defocus detection pixel 302. The defocus detection pixel 302 includes a first subpixel 110, a second subpixel 120, another second subpixel 220, and another first subpixel 140. In the embodiment, the first subpixel 110, the second subpixel 120 and the other first subpixel 140 may have the same designs as the first subpixel 110, the second subpixel 120 and the other first subpixel 140 depicted in FIG. 1, respectively. In addition, the second subpixel 220 may have the same design as the second subpixel 220 depicted in FIG. 4. The pixels 104 are the same as those described in the previous embodiments of FIG. 1, and each of the pixels 104 includes image subpixels 150 arranged in a 2×2 array.

In the embodiment, the first subpixel 110, the other first subpixel 140 and the image subpixels 150 are respectively implemented by a QPD configuration while the second subpixel 120 and the second subpixel 220 are respectively implemented by a 4C configuration. The method M01 depicted in FIG. 2 may be applicable to the image sensor 300, wherein the second readout value B₁ . . . Bₙ may be optionally selected from the readout values of the photodiode units 122 of the second subpixel 120 or the readout values of the photodiode units 222 of the second subpixel 220. In some embodiments, the defocus maps obtained by using the readout values of the photodiode units 122 of the second subpixel 120 and the readout values of the photodiode units 222 of the second subpixel 220 may be combined and/or analyzed to obtain a combined defocus map for determining the defocus level, but the disclosure is not limited thereto.

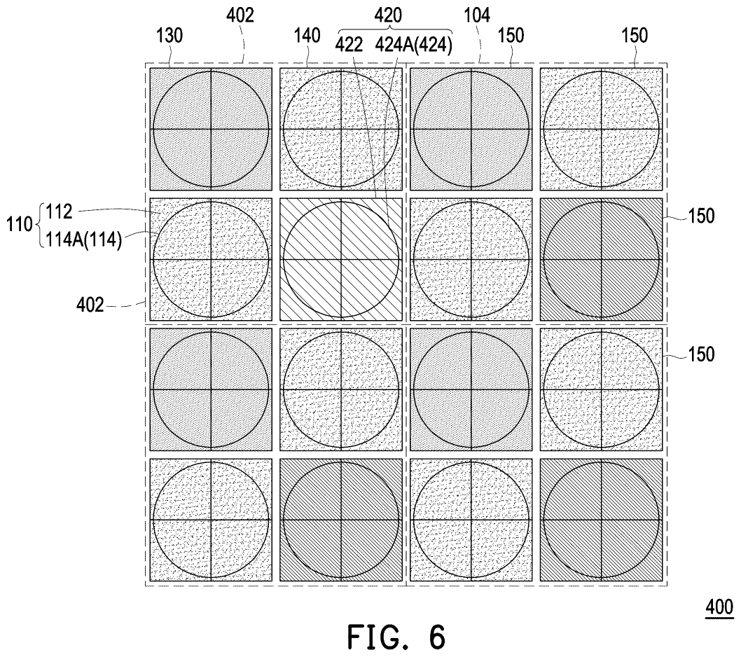

FIG. 6 is a schematic diagram of an image sensor in accordance with an embodiment of the disclosure. An image sensor 400 shown in FIG. 6 includes an array of pixels and the pixels include a defocus detection pixel 402 and other pixels 104 around the defocus detection pixel 402. The defocus detection pixel 402 may be implemented by a complex microlens structure and the pixels 104 may be respectively implemented by a uniformed microlens structure. The defocus detection pixel 402 of the image sensor 400 includes a first subpixel 110, a second subpixel 420, a third subpixel 130 and another first subpixel 140 arranged in a 2×2 array, in which the second subpixel 420 has a different microlens structure from other subpixels in the defocus detection pixel 402. For descriptive purpose, the subpixel having a different microlens structure is filled with loose pattern while other subpixels are filled with dense patterns. However, the density of the patterns does not limit to a specific structure in FIG. 6 and other drawings.

In the embodiment, the pixel 104 includes image subpixels 150 arranged in a 2×2 array, in which the image subpixels 150 are implemented by the same microlens configuration. In the defocus detection pixel 402, the first subpixel 110 located at the lower left portion is a green subpixel, the second subpixel 420 located at the lower right portion is a red subpixel, the third subpixel 130 located at the upper left portion is a blue subpixel and the other first subpixel 140 located at the upper right portion is another green subpixel, such that the defocus detection pixel 402 forms a Bayer pattern arrangement. The pixels 104 may be also implemented by a Bayer pattern arrangement, where two green subpixel are diagonally arranged at two corners in a 2×2 array, and one blue subpixel and one red subpixel are diagonally arranged at the other two corners in the 2×2 array. The image sensor 400 is implemented by the red subpixel having a different microlens structure from other subpixels, but the disclosure is not limited thereto.

In the embodiment, the design of the first subpixel 110, the third subpixel 130, the other first subpixel 140 and the image subpixels 150 may refer to the descriptions of the embodiment of FIG. 1 and not be reiterated here. For example, the first subpixel 110 includes photodiode units 112 and a first microlens structure 114, the third subpixel 130 includes photodiode units 132 and a third microlens structure 134, the other first subpixel 140 includes photodiode units 142 and an another first microlens structure 144, and the image subpixels 150 includes photodiode units 152 and a repeating microlens structure 154. In addition, all the first subpixel 110, the third subpixel 130, the other first subpixel 140 and the image subpixels 150 may be respectively implemented by a QPD configuration.

In the embodiment, the second subpixel 420 is also implemented by a QPD configuration and include photodiode units 422 and a second microlens structure 424. The microlens 424A in the second microlens structure 424 though has a substantially the same structure as the microlens 114A in the first microlens structure 114 of the first subpixel 110, has a different height from the microlens 114A. In the embodiment, the method M01 is applicable to the image sensor 400 to detect the defocus of the image sensor 400.

FIG. 7 is a schematic diagram of a side view of two subpixels in accordance with some embodiments of the disclosure. Referring to FIG. 7, the subpixel SPA includes photodiode units PDA and a microlens structure MSA. The microlens structure MSA may include one single microlens LSA covering 2×2 photodiode units PDA in the top view while the sideview of FIG. 7 shows 2 photodiode units PDA under one microlens LSA. The microlens LSA has a first height H1. The subpixel SPB is located next to the subpixel SPA and includes photodiode units PDB and a microlens structure MSB. The microlens structure MSB may include one single microlens LSB covering 2×2 photodiode units PDB in the top view while the sideview of FIG. 7 shows 2 photodiode units PDB under one microlens LSB. The microlens LSB has a second height H2 different from the first height H1.

In some embodiments, a height difference between the microlens structure MSA and the microlens structure MSB is 10% to 30% of a height of a shorter one of the microlens structure LSA and the microlens structure LSB. For example, the height difference between the first height H1 and the second height H2 may be 10% to 30% of the second height H2. The structure of the two subpixels SPA and SPB may be applicable to the embodiments that the second subpixel has a different microlens height from other subpixels. For example, the structure of FIG. 7 may be applicable to the embodiment of FIG. 6, where one of the first subpixel 110 and the second subpixel 420 may be the subpixel SPA and the other may be the subpixel SPB, or vice versa.

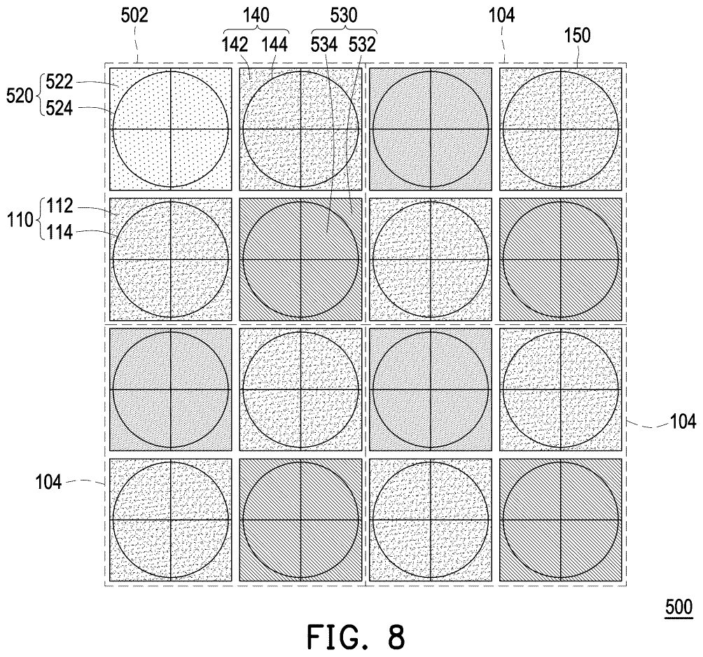

FIG. 8 is a schematic diagram of an image sensor in accordance with an embodiment of the disclosure. An image sensor 500 shown in FIG. 8 includes an array of pixels and the pixels include a defocus detection pixel 502 and other pixels 104 around the defocus detection pixel 502. The defocus detection pixel 502 may have a complex microlens structure and the pixels 104 may have uniformed microlens structures. The defocus detection pixel 502 of the image sensor 500 includes a first subpixel 110, a second subpixel 520, a third subpixel 530 and another first subpixel 140 arranged in a 2×2 array, in which the second subpixel 520 has a different microlens structure from other subpixels in the defocus detection pixel 402. Each of the pixels 104 includes image subpixels 150 arranged in a 2×2 array, in which the image subpixels 150 are implemented by the same microlens structure.

In the embodiment, the first subpixel 110 includes photodiode units 112 and a first microlens structure 114, the second subpixel 520 includes photodiode units 522 and a second microlens structure 524, the third subpixel 530 includes photodiode units 532 and a third microlens structure 534, the other first subpixel 140 includes photodiode units 142 and an another first microlens structure 144, and the image subpixels 150 includes photodiode units 152 and a repeating microlens structure 154.

In the embodiment, the first microlens structure 114 includes a single microlens overlaying 2×2 photodiodes 112, the second microlens structure 524 includes a single microlens overlaying 2×2 photodiodes 522, the third microlens structure 534 includes a single microlens overlaying 2×2 photodiodes 532, the other first microlens structure 144 includes a single microlens overlaying 2×2 photodiodes 142, and the repeating microlens structure 154 includes a single microlens overlaying 2×2 photodiodes 152. Accordingly, all the subpixels in the image sensor 500 are implemented by a QPD configuration. The first microlens structure 114, the third microlens structure 534, the other first microlens structure 144 and the repeating microlens structure 154 may have substantially the same height, but the second microlens structure 524 has a different height from the first microlens structure 114.

In defocus detection pixel 502 of the embodiment, the first subpixel 110 located at the lower left portion is a green subpixel, the second subpixel 520 located at the upper left portion is a blue subpixel, the third subpixel 530 located at the lower right portion is a red subpixel and the other first subpixel 114 located at the upper right portion is another green subpixel, which form a Bayer pattern arrangement. Accordingly, the image sensor 500 is implemented by the blue subpixel having a different microlens structure from other subpixels in the defocus detection pixel 502. In the embodiment, the method M01 depicted in FIG. 2 may be applicable to the image sensor 600 and performed by using the readout values and positions of the photodiode units 522 under the second microlens structure 524 of the second subpixel 520 (blue subpixel) to obtain a defocus map for detecting defocus of the image sensor 500.

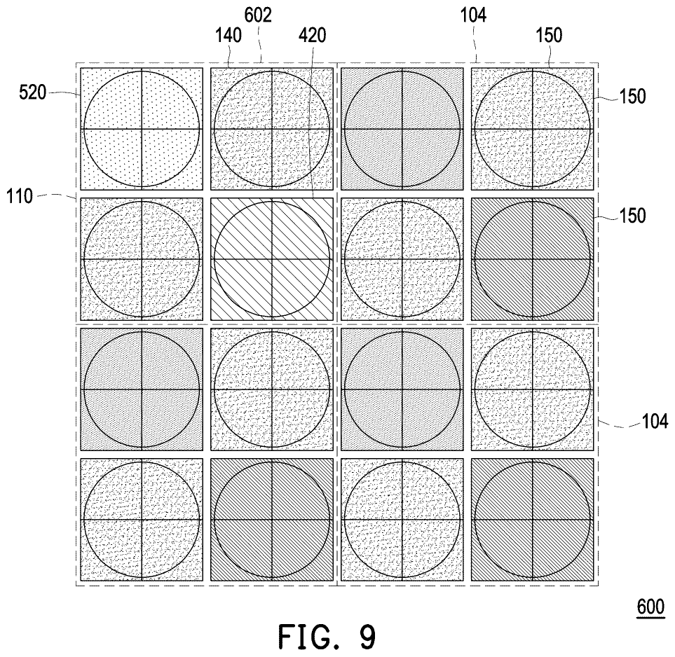

FIG. 9 is a schematic diagram of an image sensor in accordance with an embodiment of the disclosure. An image sensor 600 shown in FIG. 9 includes an array of a defocus detection pixel 602 and other pixels 104 around the defocus detection pixel 602. The defocus detection pixel 602 includes a first subpixel 110, a second subpixel 420, another second subpixel 520, and another first subpixel 140. In the embodiment, the first subpixel 110 and the other first subpixel 140 may have the same designs as the first subpixel 110 and the other first subpixel 140 depicted in FIG. 1, respectively. In addition, the second subpixel 420 may have the same design as the second subpixel 420 depicted in FIG. 6, and the second subpixel 520 may have the same design as the second subpixel 520 depicted in FIG. 8. The pixels 104 are the same as those described in the previous embodiments, and each pixel 104 includes image subpixels 150 arranged in a 2×2 array. In the embodiment, the first subpixel 110, the second subpixel 420, the second subpixel 520, the other first subpixel 140 and the image subpixels 150 are respectively implemented by a QPD configuration while the microlens height of the second subpixel 420 and the microlens height of the second subpixel 520 are different from other subpixels.

The method M01 depicted in FIG. 2 may be applicable to the image sensor 600, wherein the second readout values B₁ . . . Bₙ may be optionally selected from the readout values of the photodiode units of the second subpixel 420 or the readout values of the photodiode units of the second subpixel 520. In some embodiments, the defocus maps obtained by using the readout values and positions of the photodiode units of the second subpixel 420 and the readout values and positions of the photodiode units of the second subpixel 520 may be combined and/or analyzed to obtain a combined defocus map for determining the defocus of the image sensor 600.

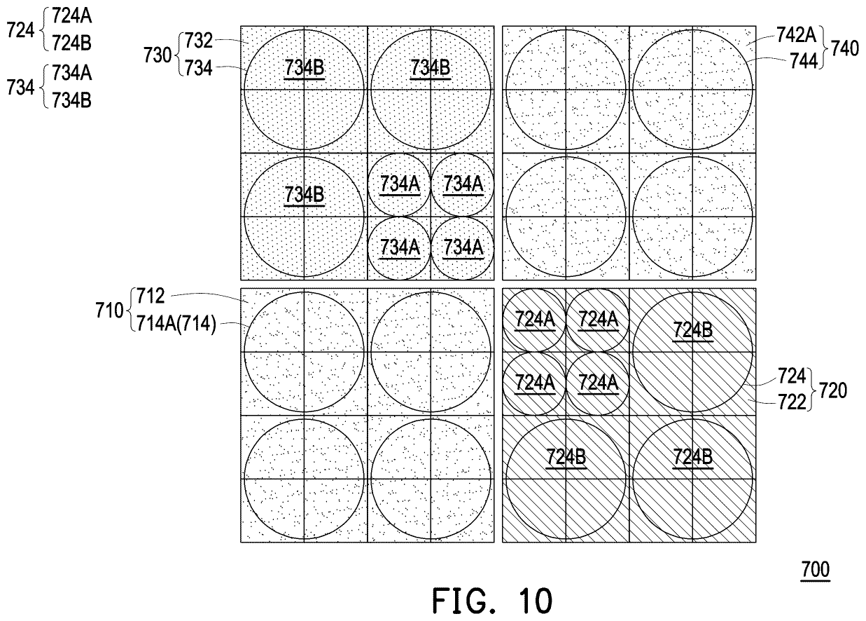

FIG. 10 shows a schematic diagram of a defocus detection pixel in an image sensor in accordance with an embodiment of the disclosure. Referring to FIG. 10, the defocus detection pixel 700 includes a first subpixel 710, a second subpixel 720, another second subpixel 730 and another first subpixel 740 formed in a 2×2 array, wherein the first subpixel 710 and the other first subpixel 740 are diagonally arranged and implemented by the same microlens design, and the second subpixel 720 and the other second subpixel 730 are diagonally arranged and implemented by a similar microlens design. The microlens design implemented in the first subpixel 710 and the other first subpixel 740 is different from the microlens design implemented in the second subpixel 720 and the other second subpixel 730. In the embodiment, the first subpixel 710 and the other first subpixel 740 are green subpixels, the second subpixel 720 is a red subpixel and the other second subpixel 730 is a blue subpixel, to form a Bayer pattern arrangement.

The first subpixel 710 includes m photodiode units 712 providing first readout values and a first microlens structure 714 overlaying the photodiode units 712. In the embodiment, m is 16, the first subpixel 710 includes 16 photodiode units 712 arranged in a 4×4 array, and the first microlens structure 714 may include 4 microlenses 714A arranged in a 2×2 array overlaying the 16 photodiode units 712. Each of the microlenses 714A covers 4 photodiode units 712 arranged in a 2×2 array to form a unit having QPD configuration, a QPD unit and the first subpixel 710 is formed by 4 QPD units arranged in a 2×2 array. The 16 photodiode units 712 are binned to sense the same color of the incident light. In some embodiments, the readout values of the photodiode units 712 indicate the intensity of green of the incident light. Accordingly, the first subpixel 710 is a green subpixel.

The second subpixel 720 includes m photodiode units 722 providing second readout values and a second microlens structure 724 overlaying the photodiode units 722, wherein m is 16. In the embodiment, the second microlens structure 724 include microlenses 724A and microlenses 724B. Each of the microlenses 724A has a smaller size then each of the microlenses 724B in the second microlens structure 724. For example, each of the microlenses 724A covers one single photodiode unit 722 and each of the microlenses 724B covers 2×2 photodiode units 722. Each of the microlenses 724B may have a structure the same as the microlenses 714A in the first microlens structure 714. The arrangement of 4 microlenses 724A of the second microlens structure 724 forms a 4C configuration and the arrangement of each microlens 724B of the microlens structure 724 forms a QPD configuration. In the embodiment, an upper left portion of the second subpixel 720 is implemented by a 4C configuration while an upper right portion, a lower left portion and a lower right portion of the second subpixel 720 are implemented by a QPD configuration, so that the second subpixel 720 has a different microlens structure from the first subpixel 710 implemented by a 4×4 array of QPD units.

The other second subpixel 730 is implemented by a similar microlens design as the second subpixel 720. Specifically, the second subpixel 730 includes m photodiode units 732 providing second readout values and a second microlens structure 734 overlaying the photodiode units 732, wherein m is 16. The second microlens structure 734 include microlenses 734A and microlenses 734B. Each of the microlenses 734A covers one single photodiode unit 732 and each of the microlenses 734B covers 2×2 photodiode units 732. The second subpixel 730 is divided into four portions, where the 2×2 photodiodes 732 at the lower right portion are covered by the microlenses 734A to form a 4C unit, the 2×2 photodiodes 732 at the upper right portion are covered by the microlenses 734B to form a QPD unit n, the 2×2 photodiodes 732 at the upper left portion are covered by the microlenses 734B to form a QPD unit n, and the 2×2 photodiodes 732 at the lower left portion are covered by the microlenses 734B to form a QPD unit.

The other first subpixel 740 is implemented by the same design of the first subpixel 710. Specifically, the other first subpixel 740 includes 16 photodiode units 742 arranged in a 4×4 array and an another first microlens structure 744 including 4 microlenses 744A arranged in a 2×2 array. Each of the microlenses 744A of the other first microlens structure 744 covers four photodiode units 742 in a 2×2 array to form a QPD unit and thus the other first subpixel 740 is formed by four QPD units arranged in a 2×2 array.

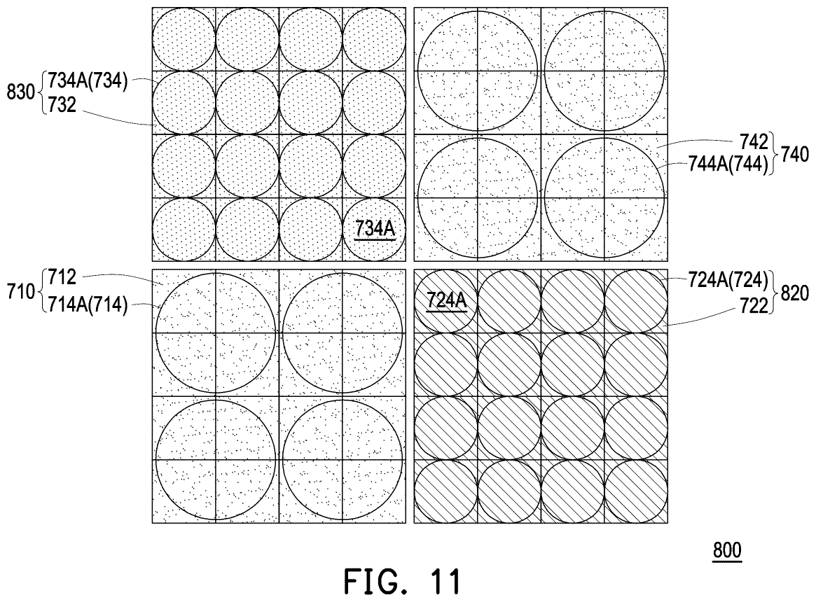

In the embodiment, a portion of the second subpixel 720/730 is implemented by the microlenses 724A/734A having a different microlens structure than the first subpixel 710 and the other first subpixel 740. For example, the different microlens structure portion of the second subpixel 720/730 is a 4C unit. The method M01 depicted in FIG. 2 may be applicable by using the positions and the readout values of n photodiodes 722/732 covered by the microlenses 724A/734A to detect defocus of the defocus detection pixel 700, wherein m photodiode units 722/732 are included in the second subpixel 720/730 and m is greater than n. In the embodiment, the 4C unit in the second subpixel 720 is arranged at the upper left portion and the 4C unit in the second subpixel 730 is arranged at the lower right portion, but the disclosure is not limited thereto. In some alternative embodiments, the 4C unit in the second subpixel 720 or the second subpixel 730 may be arranged at another portion of a second subpixel. In some alternative embodiments, the 4C unit may be implemented in two or more portions of the second subpixel 720 or the second subpixel 730. For example, FIG. 11 shows that a second subpixel is divided into four portions, and all the four portions are implemented by 4C configuration.

FIG. 11 is a schematic diagram of a defocus detection pixel in an image sensor in accordance with an embodiment of the disclosure. Referring to FIG. 11, the defocus detection pixel 800 includes a first subpixel 710, a second subpixel 820, another second subpixel 830 and another first subpixel 740 arranged in a 2×2 array, wherein the first subpixel 710 and the other first subpixel 740 are diagonally arranged and implemented by the same design, and the second subpixel 820 and the other second subpixel 830 are diagonally arranged and implemented by a similar design. In the embodiments, the first subpixel 710 and the other first subpixel 740 are green subpixels, the second subpixel 820 is a red subpixel and the other second subpixel 830 is a blue subpixel, which form a Bayer pattern arrangement.

Herein, the first subpixel 710 and the fourth subpixel 740 may be implemented by the same design as those described in the previous embodiment of FIG. 10. For example, the first subpixel 710 includes 4×4 photodiode units 712 and a first microlens structure 714 of 2×2 microlenses 714A, and the other first subpixel 740 includes 4×4 photodiode units 742 and another first microlens structure 744 of 2×2 microlenses 744A.

The second subpixel 820 includes m photodiode units 722 providing second readout values and a second microlens structure 824 overlaying the photodiode units 722, wherein m is 16. The second microlens structure 824 include 16 microlenses 724A arranged in a 4×4 array overlaying the 4×4 photodiode units 722. Each of the photodiode units 722 in the second subpixel 820 is covered by one single microlens 724A, each of the microlenses 724A in the second subpixel 820 overlaps one single photodiode unit 722, and the second subpixel 820 is implemented by a 4×4 array of a structure that one microlens-to-one photodiode unit. In other words, the second subpixel 820 may be divided into 4 portions arranged in a 2×2 array and each of the portions is implemented by a unit of 4C configuration. In other words, the second subpixel 720 has four 4C units arranged in a 2×2 array.

The other second subpixel 830 is implemented by a microlens design the same as the second subpixel 820. Specifically, the second subpixel 830 includes m photodiode units 732 providing other second readout values and a second microlens structure 834 overlaying the photodiode units 732, wherein m is 16. The second microlens structure 834 include 16 microlenses 734A arranged in a 4×4 array overlaying the 4×4 photodiode units 732. The second subpixel 830 is implemented by 4×4 array of a structure that one microlens-to-one photodiode unit. In other words, the other second subpixel 830 has four 4C units arranged in a 2×2 array.

The other first subpixel 740 is implemented by the same design as the first subpixel 710. Specifically, the other first subpixel 740 includes 16 photodiode units 742 arranged in a 4×4 array and an another first microlens structure 744 including 4 microlenses 744A arranged in a 2×2 array. Each of the microlenses 744A of the other first microlens structure 744 covers four photodiode units 742 in a 2×2 array to form a QPD unit and the other first subpixel 740 is formed by four QPD units arranged in a 2×2 array.

The method M01 depicted in FIG. 2 is applicable to the image sensor including the defocus detection pixel 800 to detect defocus of the sensed image by using the readout values from the photodiode units 722/732 covered by the microlenses 724A/734A in the second subpixel 820/830. For example, the first readout values of the photodiode units 712 and 742 of the first subpixels 710 and 740 are interpolated to positions of n of the photodiode units 722 or 732 to obtain interpolated values. In some embodiment, the step S106 in the method M01 depicted in FIG. 2 may be performed for 2×2 photodiodes 722 or 732 arranged in a 4C unit, so that n is 4. In some embodiments, the step S106 in the method M01 depicted in FIG. 2 may be performed four times until the imbalance values at all the 4C units of the second subpixel 720 or 730 are obtained. In addition, the imbalance value may be obtained by using a combination of the equations 1-10 described in the descriptions of FIG. 2, but the disclosure is not limited thereto. In some embodiments, the defocus map obtained by using the readout values of the second subpixel 720 and the defocus map obtained by using the readout values of the other second subpixel 730 may be combined or analyzed to be utilized for detecting the defocus of the image sensor including the defocus detection pixel 800.

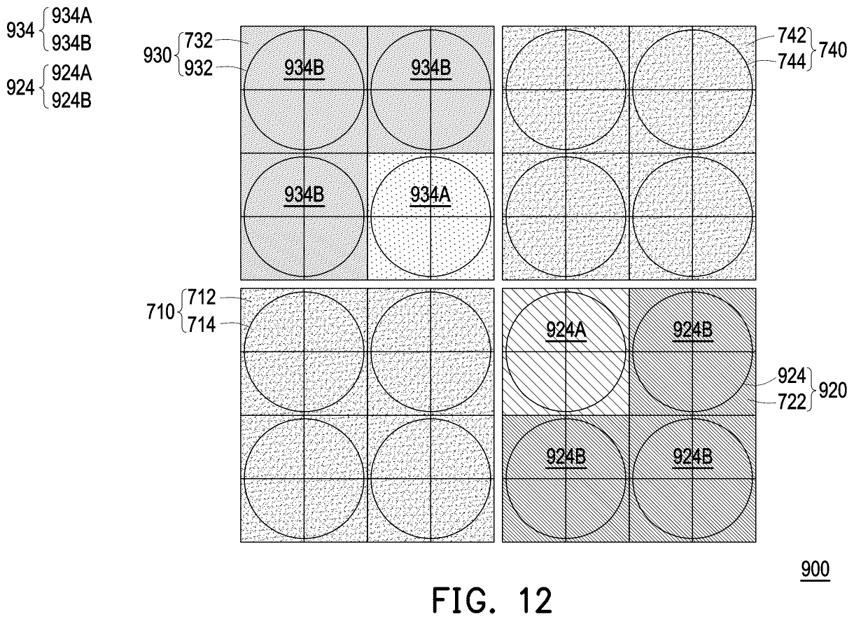

FIG. 12 a schematic diagram of a defocus detection pixel in an image sensor in accordance with an embodiment of the disclosure. Referring to FIG. 12, the defocus detection pixel 900 includes a first subpixel 710, a second subpixel 920, another second subpixel 930 and another first subpixel 740 formed in a 2×2 array. In the embodiment, the first subpixel 710 and the other first subpixel 740 are diagonally arranged and implemented by the same microlens design. The first subpixel 710 includes 16 photodiode units 712 and a first microlens structure 714, and the other first subpixel 740 includes 16 photodiode units 742 and another first microlens structure 744, wherein the designs of the first subpixel 710 and the other first subpixel 740 may refer to the previous embodiment depicted in FIG. 10 and not be reiterated here. For example, each of the first subpixel 710 and the other first subpixel 740 is implemented by 2×2 QPD units, in which the microlenses of the first microlens structure 714 and the other first microlens structure 744 have a common shape and a common size in both top view and the side view. The second subpixel 920 and the other second subpixel 930 are diagonally arranged and implemented by a different microlens design from the first subpixel 710/740.

The second subpixel 920 includes m photodiode units 722 providing second readout values and a second microlens structure 924 overlaying the photodiode units 722, wherein m is 16. The second microlens structure 734 include one microlens 924A and three microlenses 924B arranged in a 2×2 array. The microlens 924A is located at the upper left portion of the 2×2 array and the microlenses 924B are located at other portions of the 2×2 array. Each of the microlens 924A and the microlenses 924B covers 2×2 photodiode units 722 to form a QPD unit. In other words, the second subpixel 920 is implemented by four QPD units arranged in a 2×2 array.

In the embodiment, the microlens 924A has a different height e from the microlenses 924B while the microlenses 924B are implemented by the same structure as the microlenses 714/744 of the first subpixel 710/740. Accordingly, the second subpixel 920 has a different microlens structure from the first subpixel 710/740. In some embodiments, the microlens 924A is higher or shorter than the microlenses 924B and the microlenses 714/744. In some embodiments, a height difference between the microlens 924A and each of the microlens 714/744/924B is 10% to 30% of a height of a shorter one of the microlens 924A and the each of the microlens 714/744/924B. In some embodiments, the height relationship between the microlens 924A and the microlens 714/744 may refer to the description depicted in FIG. 7.

The other second subpixel 930 has a similar structure as the second subpixel 920. The second subpixel 930 includes 16 photodiode units 732 and another second microlens structure 934 overlaying the photodiode units 732, wherein the second microlens structure 934 includes one microlens 934A and three microlenses 934B arranged in a 2×2 array. Each of the microlens 934A and the three microlenses 934B covers 2×2 photodiode units 732 to form a QPD unit. The microlens 934A is located at the lower right portion of the 2×2 array while the three microlenses 934B are located at other portions of the 2×2 array. The microlens 934A has a different height from the three microlenses 934B and each of the three microlenses 934B has the same height as the microlenses 714/744 in the first subpixel 710/740. Therefore, the second subpixel 930 has a different microlens structure from the first subpixel 710/740 in the side view. In addition, the microlens 934A having a different height is located at the lower right portion of the second subpixel 930 while the microlens 924A having a different height is located at the upper left portion of the second subpixel 930. In other words, both subpixels, the second subpixel 920 and the other second subpixel 930, are implemented by four QPD units with complex microlens structure, the microlens having a specific height is disposed at different portion of the subpixels.

The method M01 depicted in FIG. 2 is applicable to an image sensor including the defocus detection pixel 900, wherein the second readout values and the positions of the photodiode units 722/732 covered by the microlens 924A/934A having a different height from other microlenses are used to obtain the parameters such as the first imbalance and the second imbalance in the method M01.

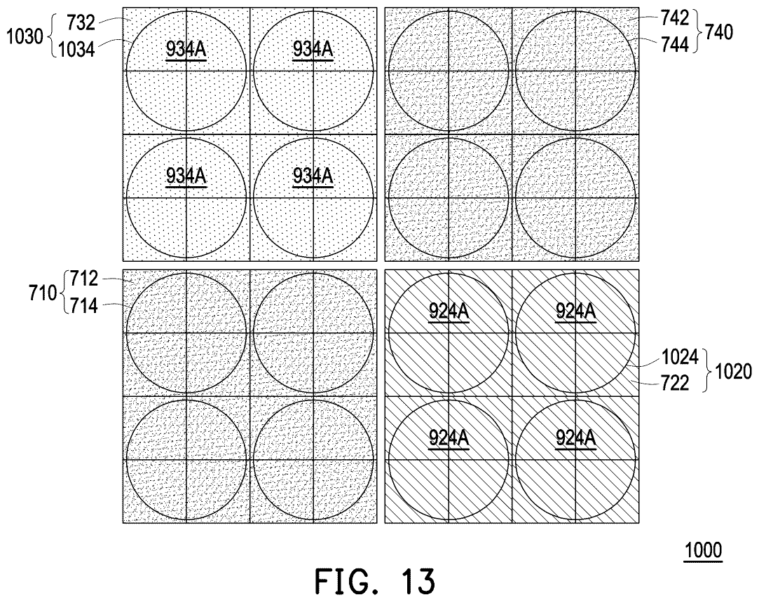

FIG. 13 a schematic diagram of a defocus detection pixel in an image sensor in accordance with an embodiment of the disclosure. Referring to FIG. 13, the defocus detection pixel 1000 includes a first subpixel 710, a second subpixel 1020, another second subpixel 1030 and another first subpixel 740 formed in a 2×2 array, wherein the first subpixel 710 and the other first subpixel 740 are diagonally arranged and implemented by the same microlens design, and the second subpixel 1020 and the other second subpixel 1030 are diagonally arranged and implemented by similar microlens designs. The embodiment of FIG. 13 is similar to the embodiment of FIG. 12, and is different in that the second microlens structure 1024 in the second subpixel 1020 includes four microlenses 924A arranged in a 2×2 array and the second microlens structure 1034 in the second subpixel 1030 includes four microlenses 934A arranged in a 2×2 array. In addition, each of the microlenses 924A in the second subpixel 1020 and the microlenses 934A in the second subpixel 1030 has a different height from the microlenses 714/744 in the first subpixel 710/740. The height relationship between the microlenses 924A/934A and other microlenses in the defocus detection pixel 1000 may refer to the description of FIG. 7. The method M01 depicted in FIG. 2 may be applicable to an image sensor including the defocus detection pixel 1000, in which the step S106 may be performed by using the readout values provided by the 2×2 photodiode units 722/732 covered by one of the microlenses 924A/924B. In some embodiments, the step S106 may be performed several times until the photodiode units 722/732 covered by the readout values provided by all the microlenses 924A/924B are utilized.

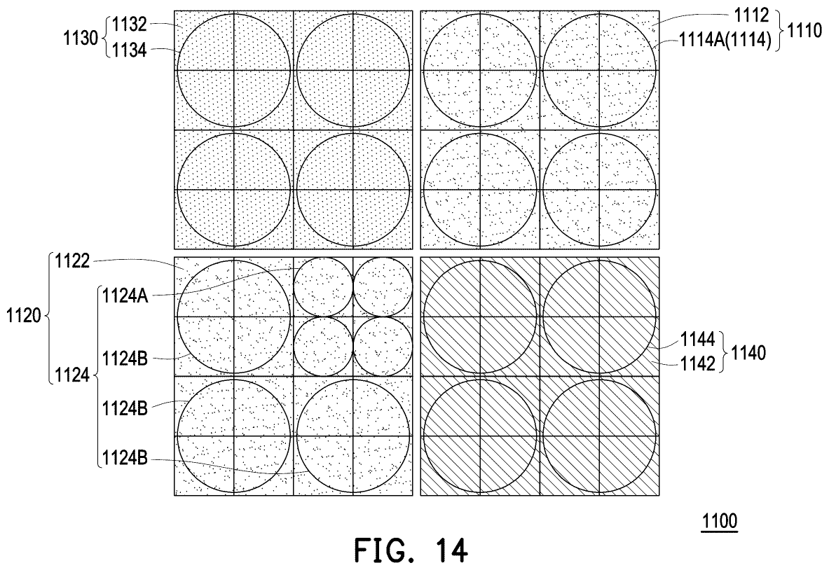

FIG. 14 a schematic diagram of a defocus detection pixel in an image sensor in accordance with an embodiment of the disclosure. Referring to FIG. 14, the defocus detection pixel 1100 includes a first subpixel 1110, a second subpixel 1120, a third subpixel 1130 and a fourth subpixel 1140 arranged in a 2×2 array, wherein the first subpixel 1110 and the second subpixel 1120 are diagonally arranged and implemented by different microlens designs, and the third subpixel 1130 and the fourth subpixel 1140 are diagonally arranged and implemented by the same microlens design. In the embodiment, the first subpixel 1110 is a green subpixel located at the upper right portion, the second subpixel 1120 is another green subpixel located at the lower left portion, the third subpixel 1130 is a blue subpixel located at the upper left portion and the fourth subpixel 1140 is a red subpixel located at the lower right portion, which forms a Bayer pattern arrangement. The first subpixel 1110, the third subpixel 1130 and the fourth subpixel 1140 may have the same microlens structure.

The first subpixel 1110 includes m photodiode units 1112 providing first readout values and a first microlens structure 1114 overlaying the photodiode units 1112, wherein m is 16 and the photodiode units 1112 are arranged in a 4×4 array in the embodiment. The first microlens structure 1114 includes four microlenses 1114A arranged in a 2×2 array and each of the microlenses 1114A covers 2×2 of the photodiode units 1112. In other words, the first subpixel 1110 may be implemented by four QPD units.

The second subpixel 1120 includes m photodiode units 1122 and a second microlens structure 1124 overlaying the photodiode units 1122, wherein m is 16 and the photodiode units 1122 are arranged in a 4×4 array in the embodiment. The second microlens structure 1124 includes four microlenses 1124A and three microlenses 1124B. The first subpixel 1110 may be divided in to four units arranged in a 2×2 array. The four microlenses 1124A are disposed at the upper right portion of the second subpixel 1120 to form a 4C unit in which the four microlenses 1124A respectively cover 2×2 of the photodiode units 1122. The three microlenses 124B are respectively located at the upper left portion, the lower left portion, and the lower right portion of the second subpixel 1120. Each of the microlenses 1124B covers 2×2 of the photodiode units 1122 to form a QPD unit. In other words, the second subpixel 1120 may be implemented by one 4C unit and three QPD units.

The third subpixel 1130 includes m photodiode units 1132 and a third microlens structure 1134 overlaying the photodiode units 1132, wherein m is 16 and the photodiode units 1132 are arranged in a 4×4 array in the embodiment. The third microlens structure 1134 includes four microlenses arranged in a 2×2 array and each of the microlenses covers 2×2 of the photodiode units 1132. In other words, the third subpixel 1130 may be implemented by four QPD units.

The fourth subpixel 1140 includes m photodiode units 1142 and a fourth microlens structure 1144 overlaying the photodiode units 1142, wherein m is 16 and the photodiode units 1142 are arranged in a 4×4 array in the embodiment. The fourth microlens structure 1144 includes four microlenses arranged in a 2×2 array and each of the microlenses covers 2×2 of the photodiode units 1142. The fourth subpixel 1140 may be implemented by four QPD units.

In the embodiment, the defocus detection pixel 1100 includes four subpixels in which one of the subpixels, the second subpixel 1120 has a different microlens structure than other subpixels. The method M01 depicted in FIG. 2 may be applicable to an image sensor including the defocus detection pixel 1100 to detect the defocus of the sensed image while a green map may be obtained by using the photodiode units under a QPD units of the green subpixels. For example, the readout values provided by the photodiodes 1112 covered by the microlenses 1114A, the readout values provided by the photodiodes 1122 covered by the microlenses 1124B and other readout values provided by the photodiodes of other QPD units of other green subpixels are used to obtain the green map as shown in FIG. 3 and the interpolated values A₁ . . . Aₙ for calculating the first imbalance depicted in the step S106 of the method M01 is obtained from the green map at the positions of the photodiode units 1122 covered by the microlenses 1124A. The readout values of the photodiode units 1122 covered by the microlenses 1124A are used as the second readout values B₁ . . . Bₙ to calculate the second imbalance depicted in the step S106 of the method M01. The imbalance value is than obtained by using the combination of the equations 1˜9 described in the previous embodiment.

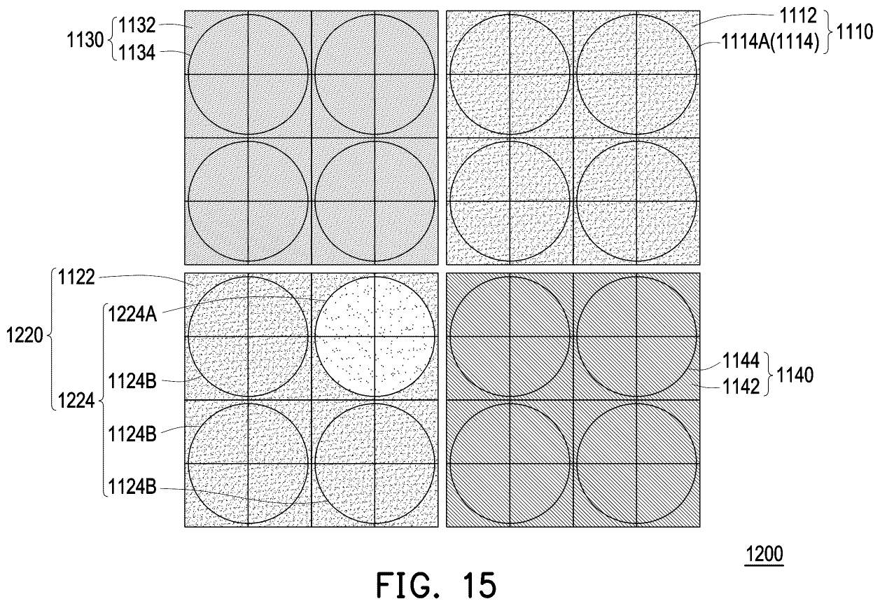

FIG. 15 a schematic diagram of a defocus detection pixel in an image sensor in accordance with an embodiment of the disclosure. Referring to FIG. 15, the defocus detection pixel 1200 includes a first subpixel 1110, a second subpixel 1220, a third subpixel 1130 and a fourth subpixel 1140 arranged in a 2×2 array, wherein the first subpixel 1110 and the second subpixel 1120 are diagonally arranged, and the third subpixel 1130 and the fourth subpixel 1140 are diagonally arranged. In the embodiment, the first subpixel 1110 is a green subpixel located at the upper right portion, the second subpixel 1120 is another green subpixel located at the lower left portion, the third subpixel 1130 is a blue subpixel located at the upper left portion and a fourth subpixel 1140 is a red subpixel located at the lower right portion, which form a Bayer pattern arrangement. In the embodiment, the second subpixel 1220 has a different microlens structure than the first subpixel 1110, the third subpixel 1130 and the fourth subpixel 1140. Specifically, the microlens designs of the first subpixel 1110, the third subpixel 1130 and the fourth subpixel 1140 may refer to the embodiment of FIG. 14. In other words, the defocus detection pixel 1200 of the embodiment is different from the defocus detection pixel 110 in the microlens structure of the second subpixel 1120.

The second subpixel 1120 includes m photodiode units 1122 and a second microlens structure 1224 overlaying the photodiode units 1122, wherein m is 16 and the photodiode units 1122 are arranged in a 4×4 array in the embodiment. The second microlens structure 1224 includes one microlens 1224A and three microlenses 1124B arranged in in a 2×2 array. In the embodiment, the microlens 1224A is located at the upper right portion of the second subpixel 1220 and three microlenses 1124B are located at the upper left portion, the lower left portion, and the lower right portion of the second subpixel 1220. The microlens 1224A and the microlenses 1124B may have the same top view size as the microlenses 1114A in the first subpixel 1110, but the microlens 1224A has a different height from the microlenses 1114A in the first subpixel 1110 and the microlenses 1124B. In some embodiments, the microlens 1224A has a height taller than the microlenses 1114A in the first subpixel 1110. In some embodiments, the microlens 1224A has a height shorter than the microlenses 1114A in the first subpixel 1110. In some embodiments, a height difference between the microlenses 1114A in the first microlens structure 1114 and the microlens 1224A of the second microlens structure 1224 is 10% to 30% of a height of a shorter one of the microlenses 1114A and the microlens 1224A. In some embodiments, the method M01 is applicable to an image sensor including the defocus detection pixel 1200 by using the readout values of the 2×2 photodiodes 1122 under the microlens 1224A having a different height as the second readout values B₁˜Bₙ.

In view of the above, an image sensor in accordance with some embodiments of the disclosure includes a defocus detection pixel implemented by a first subpixel and a second subpixel having a different microlens structure from the first subpixel. In some embodiments, the different microlens includes a different size from other microlenses in the top view or in the side view. The defocus of an image sensor is detected by using the readout values and the positions of the photodiodes cover by the different microlens(es) of the second subpixel. Accordingly, the image sensor may detect whether a defocus occurs using the provided method.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method of detecting a defocus of an image sensor, comprising:
providing an image sensor comprising a plurality of pixels, a pixel comprising a first subpixel and a second subpixel, wherein the first subpixel comprises m photodiode units providing first readout values and a first microlens structure overlaying the photodiode units, the second subpixel comprises m photodiode units providing second readout values and a second microlens structure overlaying the photodiode units, and the first microlens structure is structurally different from the second microlens structure, wherein m is a positive integer;
interpolating the first readout values of the photodiode units of the first subpixel to positions of n of the photodiode units of the second subpixel to obtain interpolated values, wherein n is a positive integer; and
obtaining an imbalance value by using the interpolated values and the second readout values provided by the n of the photodiode units of the second subpixel.

2. The method of claim 1, further obtaining a defocus map based on the imbalance value.

3. The method of claim 2, further performing an up-sample step prior to obtaining the defocus map.

4. The method of claim 1, wherein the imbalance value imbal_diff is obtained by
$$imbal\_diff = \frac{i m b a {l}_{A}}{i m b a {l}_{B}} - 1 ,$$
wherein imbal_{A} is a first imbalance, and imbal_{B} is a second imbalance.

5. The method of claim 4, wherein the first imbalance is obtained by
$${imbal}_{A} = \frac{max ( {A}_{1} , {A}_{2} , … {A}_{n} )}{min ( {A}_{1} , {A}_{2} , … {A}_{n} )} ,$$
wherein A₁ . . . Aₙ are the interpolated values; and
the second imbalance is obtained by
$${imbal}_{B} = \frac{max ( {B}_{1} , {B}_{2} , … {B}_{n} )}{min ( {B}_{1} , {B}_{2} , … {B}_{n} )} ,$$
wherein B₁ . . . Bₙ are the second readout value provided by the n of the photodiode units of the second subpixel.

6. The method of claim 4, wherein the first imbalance is obtained by
$${imbal}_{A} = \frac{max ( {A}_{1} , {A}_{2} , … {A}_{n} )}{‖ ( {A}_{1} , {A}_{2} , … {A}_{n} ) ‖} ,$$
wherein A₁ . . . Aₙ are the interpolated values and ∥·∥ is a norm; and
the second imbalance is obtained by
$${imbal}_{B} = \frac{max ( {B}_{1} , {B}_{2} , … {B}_{n} )}{‖ ( {B}_{1} , {B}_{2} , … {B}_{n} ) ‖} ,$$
wherein B₁ . . . Bₙ are the second readout value provided by the n of the photodiode units of the second subpixel, and ∥·∥ is a norm.

7. The method of claim 1, wherein the imbalance value imbal_diff is obtained by
imbal_diff=|imbal_{A}−imbal_{B}∥, wherein imbal_{A} is a first imbalance, and imbal_{B} is a second imbalance, where ∥·∥ is a norm.

8. The method of claim 7, wherein the first imbalance is obtained by
$${imbal}_{A} = \frac{max ( {A}_{1} , {A}_{2} , … {A}_{n} )}{min ( {A}_{1} , {A}_{2} , … {A}_{n} )} ,$$
A₁ . . . Aₙ are the interpolated values; and
the second imbalance is obtained by
$${imbal}_{B} = \frac{max ( {B}_{1} , {B}_{2} , … {B}_{n} )}{min ( {B}_{1} , {B}_{2} , … {B}_{n} )} ,$$
B₁ . . . Bₙ are the second readout value provided by the n of the photodiode units of the second subpixel.

9. The method of claim 7, wherein the first imbalance is obtained by
$${imbal}_{A} = \frac{max ( {A}_{1} , {A}_{2} , … {A}_{n} )}{‖ ( {A}_{1} , {A}_{2} , … {A}_{n} ) ‖} ,$$
wherein A₁ . . . Aₙ are the interpolated values; and
the second imbalance is obtained by
$${imbal}_{B} = \frac{max ( {B}_{1} , {B}_{2} , … {B}_{n} )}{‖ ( {B}_{1} , {B}_{2} , … {B}_{n} ) ‖} ,$$
wherein B₁ . . . Bₙ are the second readout value provided by the n of the photodiode units of the second subpixel.

10. The method of claim 1, wherein n is 4,
a first imbalance patch is obtained by
$${patch}_{A} = [ \begin{matrix}{A}_{1} & {A}_{2} \\ {A}_{3} & {A}_{4}\end{matrix} ] ,$$
wherein A₁ . . . A₄ are the interpolated values; and
a second imbalance patch is obtained by
$${patch}_{B} = [ \begin{matrix}{B}_{1} & {B}_{2} \\ {B}_{3} & {B}_{4}\end{matrix} ] ,$$
wherein B₁ . . . B₄ are the second readout value provided by the n of the photodiode units of the second subpixel.

11. The method of claim 10, wherein the imbalance value imbal_{diff} is obtained by
$$i m b a {l}_{diff} = ‖ ( {∇}_{H} ( \frac{A}{‖ A ‖} ) - {∇}_{H} ( \frac{B}{‖ B ‖} ) , {∇}_{V} ( \frac{A}{‖ A ‖} ) - {∇}_{V} ( \frac{B}{‖ B ‖} ) ) ‖$$
wherein ∇_{H} means gradients along a horizontal direction, and ∇_{V} means gradients along a vertical direction in a patch, and wherein A is the first imbalance patch and B is the second imbalance patch.

12. The method of claim 10, wherein the imbalance value imbal_{diff} is obtained by
$${imbal}_{diff} = \frac{‖ ( {∇}_{H} ( \frac{A}{‖ A ‖} ) , {∇}_{V} ( \frac{A}{‖ A ‖} ) ) ‖}{‖ ( {∇}_{H} ( \frac{B}{‖ B ‖} ) , {∇}_{V} ( \frac{B}{‖ B ‖} ) ) ‖} - 1 ,$$
wherein ∇_{H} means gradients along a horizontal direction, and ∇_{V} means gradients along a vertical direction in a patch, and wherein A is the first imbalance patch and B is the second imbalance patch.

13. The method of claim 10, wherein the imbalance value imbal_{diff} is obtained by
$$imba {l}_{diff} = 1 - \frac{cov ( A , B )}{\sqrt[2]{var ( A ) var ( B )}}$$
wherein A is the first imbalance patch and B is the second imbalance patch, and wherein cov stands for covariance and var stands for variance.

14. The method of claim 1, wherein at least one of the first subpixel and the second subpixel is configured to detect green.

15. The method of claim 1, wherein m is greater than or identical to n.

16. The method of claim 1, wherein one of the first microlens structure and the second microlens structure comprises one microlens overlaying four photodiode units, and the other of the first microlens structure and the second microlens structure comprises four microlenses respectively overlaying four photodiode units.

17. The method of claim 1, wherein the first microlens structure comprises a first microlens overlaying four photodiode units of the first subpixel and the second microlens structure comprises a second microlens overlaying four photodiode units of the second subpixel, and the first microlens has a different height from the second microlens.

18. An image sensor comprising:
a defocus detection pixel comprising a first subpixel and a second subpixel, wherein the first subpixel comprises m photodiode units providing first readout values and a first microlens structure overlaying the photodiode units, the second subpixel comprises m photodiode units providing second readout values and a second microlens structure overlaying the photodiode units, and the first microlens structure has a different height from the second microlens structure, and wherein m is an integer greater than 1.

19. The image sensor of claim 18, wherein a height difference between the first microlens structure and the second microlens structure is 10% to 30% of a height of a shorter one of the first microlens structure and the second microlens structure.

20. The image sensor of claim 18, further comprising a readout circuitry electrically connected to the defocus detection pixel, wherein the readout circuitry is configured to:
interpolate the first readout values of the photodiode units of the first subpixel to positions of n of the photodiode units of the second subpixel to obtain interpolated values; and
use the interpolated values and the second readout values provided by the n of the photodiode units of the second subpixel to obtain an imbalance value, wherein n is an integer.
